(19) United States
(12) Patent Application Publication
(10) Pub. No.: US 2025/0314375 A1
(43) Pub. Date: Oct. 9, 2025

(54) ILLUMINATOR

(71) Applicant: Yazaki Corporation, Tokyo (JP)

(72) Inventors: Takahiro HORI, Shizuoka (JP); Hiroyuki SUZUKI, Shizuoka (JP)

(73) Assignee: Yazaki Corporation, Tokyo (JP)

(21) Appl. No.: 19/093,477

(22) Filed: Mar. 28, 2025

(30) Foreign Application Priority Data
Apr. 9, 2024 (JP) 2024-062560

(51) Int. Cl. F21V 33/00; F21Y 113/00

(52) U.S. Cl. CPC F21V 33/0004; F21Y 2113/00

(57) ABSTRACT

An illuminator includes: a plurality of light sources; and an exterior cover that covers at least a part of a light emission space by the plurality of light sources. The exterior cover includes a first light radiation wall and a second light radiation wall that allow light emitted from the plurality of light sources to pass therethrough to radiate the light to the outside. The first light radiation wall and the second light radiation wall are colorless transparent or milky flat plates and are continuous with each other with a linear ridge therebetween. At least one light source of the plurality of light sources emits light of variable colors.

### CROSS REFERENCE TO RELATED APPLICATION

The present application is based on, and claims priority from the Japanese Patent Application No. 2024-062560, filed on Apr. 9, 2024, the entire contents of which are incorporated herein by reference.

### TECHNICAL FIELD

The present disclosure relates to an illuminator.

### BACKGROUND

In the past, there has been provided a charging inlet which is installed in a vehicle such as an electric vehicle or a plug-in hybrid vehicle and supplies power to an on-vehicle battery from the outside of the vehicle. JP 2008-254700 A discloses a technology related to a vehicle having an illuminating portion which facilitates a coupling operation of a charging connector performed by a user by radiating light to a charging opening in a charging inlet at night when the periphery of a vehicle is dark. Further, JP 2012-253843 A discloses a technology related to a charging display device which is installed in the vicinity of a charging opening in a charging inlet and has a plurality of light sources. The plurality of light sources are located inside of a light-transmissive case, and at least one of the light sources can function as an indicator for displaying a charging state or the like of a battery.

### SUMMARY OF THE INVENTION

The illuminating portion in the vehicle disclosed in JP 2008-254700 A has only an illumination function for merely illuminating the charging opening at night or the like and does not have an indicator function for displaying a charging state or the like of a battery.

Meanwhile, according to the charging display device disclosed in JP 2012-253843A, the one light source may function as an indicator and other light sources may function as illuminations for illuminating the charging opening. However, in the charging display device, the plurality of light sources are mounted on different surfaces of a substrate, that are a front surface and a back surface, and light emission directions of the light sources are also different from each other. Therefore, an internal structure including the substrate becomes complicated, and the shape of a case as an exterior becomes complicated. This may result in lack of design.

An object of the present disclosure is to provide an illuminator having an illumination function and an indicator function with a simple structure or shape.

An illuminator according to an aspect of an embodiment includes: a plurality of light sources; and an exterior cover that covers at least a part of a light emission space by the plurality of light sources. The exterior cover includes a first light radiation wall and a second light radiation wall that allow light emitted from the plurality of light sources to pass therethrough to radiate the light to the outside. The first light radiation wall and the second light radiation wall are colorless transparent or milky flat plates and are continuous with each other with a linear ridge therebetween. At least one light source of the plurality of light sources emits light of variable colors.

According to the above configuration, it is possible to provide an illuminator having an illumination function and an indicator function with a simple structure or shape.

### BRIEF DESCRIPTION OF THE DRAWINGS

FIG. 1 is a perspective view of a charging inlet in which an illuminator according to an embodiment is attached.

FIG. 2A is a perspective view of a front side of the illuminator according to an embodiment.

FIG. 2B is a perspective view of a back side of the illuminator according to an embodiment.

FIG. 3 is an exploded perspective view of the illuminator according to an embodiment.

FIG. 4 is a perspective view of a front side of a substrate on which a first light source and a second light source are arranged.

FIG. 5 is a cross-sectional view of the illuminator illustrating a radiation state by the first light source.

FIG. 6 is a cross-sectional view of the illuminator illustrating a radiation state by the second light source.

FIG. 7 is a table illustrating a radiation pattern of the second light source corresponding to each operation status.

### DETAILED DESCRIPTION OF THE INVENTION

An illuminator according to an embodiment will be described in detail below with reference to the drawings. Note that dimensional ratios in the drawings are exaggerated for convenience of the description and may be different from actual ratios.

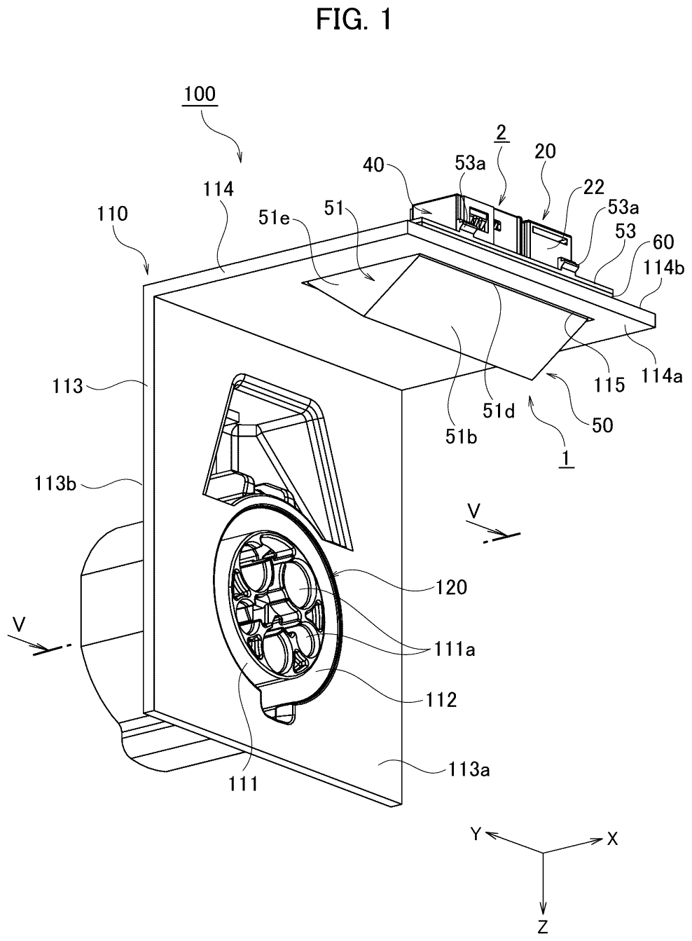

FIG. 1 is a perspective view of a charging inlet 100 to which an illuminator 1 according to one embodiment is attached.

Hereinafter, assuming that, as an example, the charging inlet 100 is installed in a vehicle and the illuminator 1 is attached to the charging inlet 100, directions are defined as follows. First, a Z direction corresponds to a vertical direction, and in the present embodiment, the Z direction also corresponds to a direction in which the illuminator 1 is attached to the charging inlet 100. Further, a horizontal plane orthogonal to the Z direction is defined as an XY plane, and an X direction and a Y direction are orthogonal to each other in the XY plane.

The charging inlet 100 is a connector which is installed in a vehicle such as an electric vehicle or a plug-in hybrid vehicle and supplies power to an on-vehicle battery by being appropriately connected to a charging connector (not illustrated) which is located outside of the vehicle. The outside charging connector is sometimes referred to as a “charging gun”. The charging inlet 100 includes a terminal holder (not illustrated) for holding a plurality of terminals and an inlet housing 110.

The inlet housing 110 is made of a synthetic resin, and the front thereof exposed to the outside when being connected to the charging connector constitutes the exterior. The inlet housing 110 includes a cylindrical portion 111, a fitting frame 112, a flange 113, and an illuminator holder 114.

The cylindrical portion 111 has a plurality of terminal accommodating chambers 111a for individually accommodating and protecting connection portions of the plurality of terminals held by the terminal holder. The shape of each terminal accommodating chamber 111a is a cylindrical shape in which an external terminal to be connected to each terminal can be inserted therein. The inlet housing 110 may have a cylindrical portion other than the cylindrical portion 111 in order to conform to various charging system standards.

The fitting frame 112 is formed conforming to the outer peripheral shape of the cylindrical portion 111 and is fitted to a part of a housing disposed in the charging connector (hereinafter referred to as “external housing”). When the external housing is fitted to the fitting frame 112, power is supplied to the on-vehicle battery from an external power source or the like, and the on-vehicle battery is charged.

The flange 113 is a flat plate portion supporting the cylindrical portion 111, the fitting frame 112, and the illuminator holder 114. The shapes of the flange 113 and the illuminator holder 114 illustrated in FIG. 1 are merely examples, and the specific shapes of the flange 113 and the illuminator holder 114 are determined according to a specification of the vehicle in which the charging inlet 100 is installed.

A surface of the flange 113 exposed to the outside is a first exterior surface 113a. The first exterior surface 113a is a vertical surface in the present embodiment, but the first exterior surface 113a may be an inclined surface having any inclination angle from the vertical surface. An opening of the cylindrical portion 111 and the fitting frame 112 opened to the outside from the first exterior surface 113a is a charging opening 120. Meanwhile, a surface of the flange 113 on the opposite side of the first exterior surface 113a is a first inner surface 113b as a rear surface on which the terminal holder is mounted.

The illuminator holder 114 is a flat plate portion which holds the illuminator 1 such that the illuminator 1 illuminates at least the charging opening 120 in the charging inlet 100. The illuminator holder 114 is disposed vertically above the charging opening 120 in the charging inlet 100 and protrudes from the first exterior surface 113a of the flange 113.

A surface of the illuminator holder 114 exposed to the outside is a second exterior surface 114a. The second exterior surface 114a is a horizontal surface in the present embodiment, but the second exterior surface 114a may be an inclined surface forming an acute or obtuse angle with the first exterior surface 113a of the flange 113, for example. Meanwhile, a surface of the illuminator holder 114 on the opposite side of the second exterior surface 114a is a second inner surface 114b as a rear surface on which the illuminator 1 is mounted.

Further, the illuminator holder 114 forms an opening passing through between the first exterior surface 113a and the second inner surface 114b, and has an illuminator attaching hole 115 for attaching the illuminator 1. Specifically, through an opening of the illuminator attaching hole 115, a part of an exterior cover 50 constituting the illuminator 1 is passed through from the second inner surface 114b side toward the second exterior surface 114a. In the present embodiment, the opening shape of the illuminator attaching hole 115 is a rectangular shape formed of two short edges in the X direction and two long edges in the Y direction.

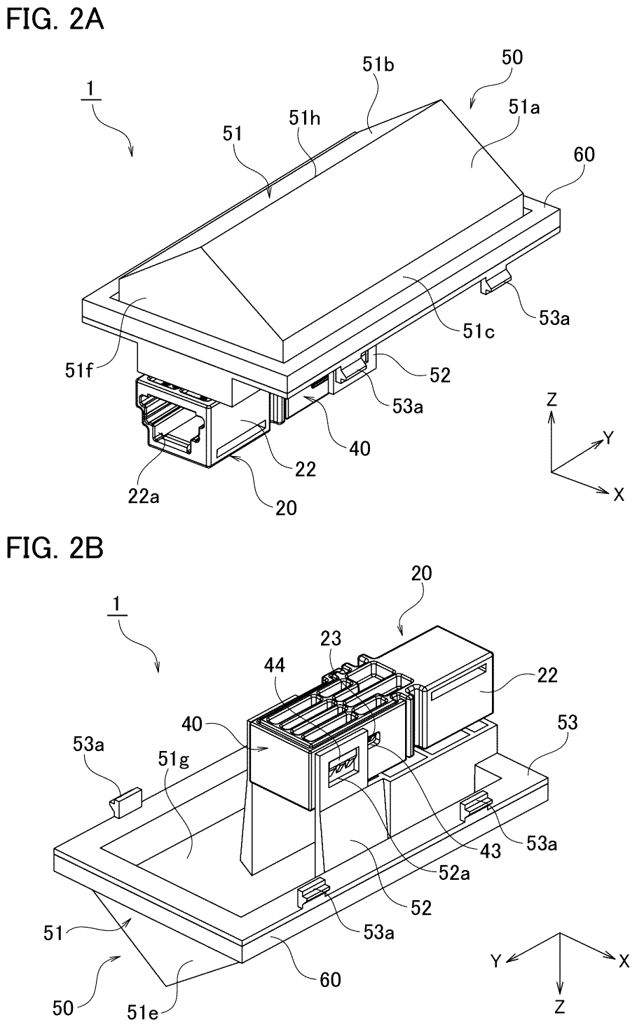

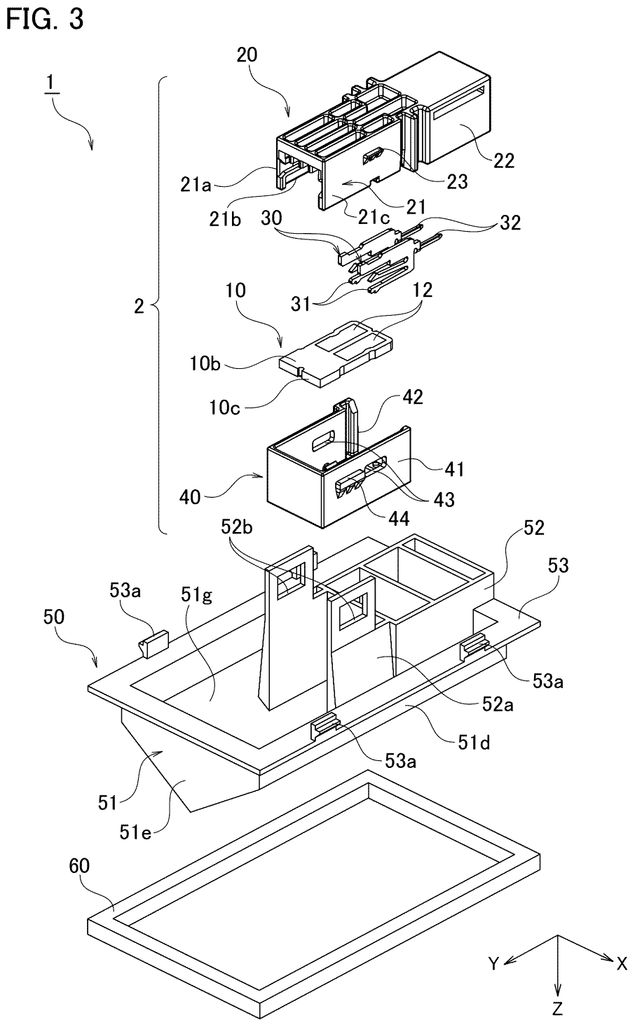

FIG. 2A is a perspective view of the illuminator 1 to make the front side of the illuminator 1 visible. FIG. 2B is a perspective view of the illuminator 1 to make the back side of the illuminator 1 visible. FIG. 3 is an exploded perspective view of the illuminator 1. Assuming that the illuminator 1 is attached to the charging inlet 100, the side exposed to the outside from the charging inlet 100 is the front side of the illuminator 1, and the side hidden inside the charging inlet 100 is the back side of the illuminator 1.

In the present embodiment, the illuminator 1 is attached to the charging inlet 100 so as to illuminate at least the charging opening 120. The illuminator 1 includes a substrate 10, a housing 20, a plurality of bus bars 30, an inner cover 40, the exterior cover 50, and a packing 60.

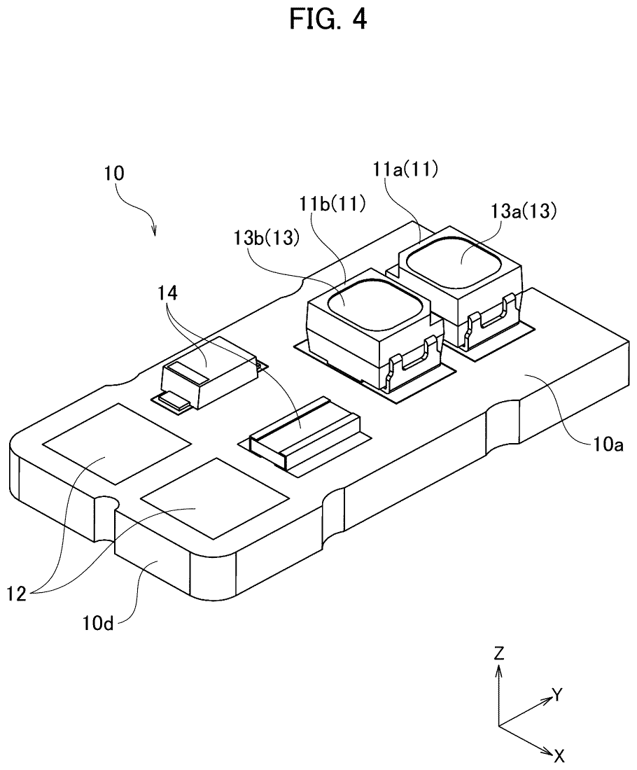

FIG. 4 is a perspective view of the substrate 10. FIG. 4 illustrates the front side of the substrate 10 on which a first light source 11a and a second light source 11b are arranged. FIG. 3 illustrates the back side of the substrate 10 where the first light source 11a and the second light source 11b are not visible.

A plurality of light sources 11 are mounted on the substrate 10. Electronic components 14 other than the plurality of light sources 11 may be mounted on the substrate 10. The schematic shape of the substrate 10 is a rectangular shape using a first substrate surface 10a and a second substrate surface 10b located opposite to each other as major planar surfaces. When the illuminator 1 is attached to the charging inlet 100, a normal direction of the first substrate surface 10a is along the Z direction, and a normal direction of the second substrate surface 10b is along a direction opposite to the Z direction. Further, the substrate 10 has a front edge 10c and a rear edge 10d along the X direction, and two side edges along the Y direction.

In the present embodiment, the substrate 10 has two light sources 11 that are the first light source 11a and the second light source 11b. Both the first light source 11a and the second light source 11b are installed on the first substrate surface 10a, and are arranged in line in the Y direction while being close to each other. Each light source 11 may be a light emitting diode (LED), an organic electro-luminescence (EL) element, or the like. A light emission direction from a first light emission surface 13a, which is a light emission surface of the first light source 11a, and a light emission direction from a second light emission surface 13b, which is a light emission surface of the second light source 11b, are both the Z direction. When the first light emission surface 13a and the second light emission surface 13b are assumed to be approximately flat, the light emission direction is synonymous with a normal direction of each of the light emission surfaces.

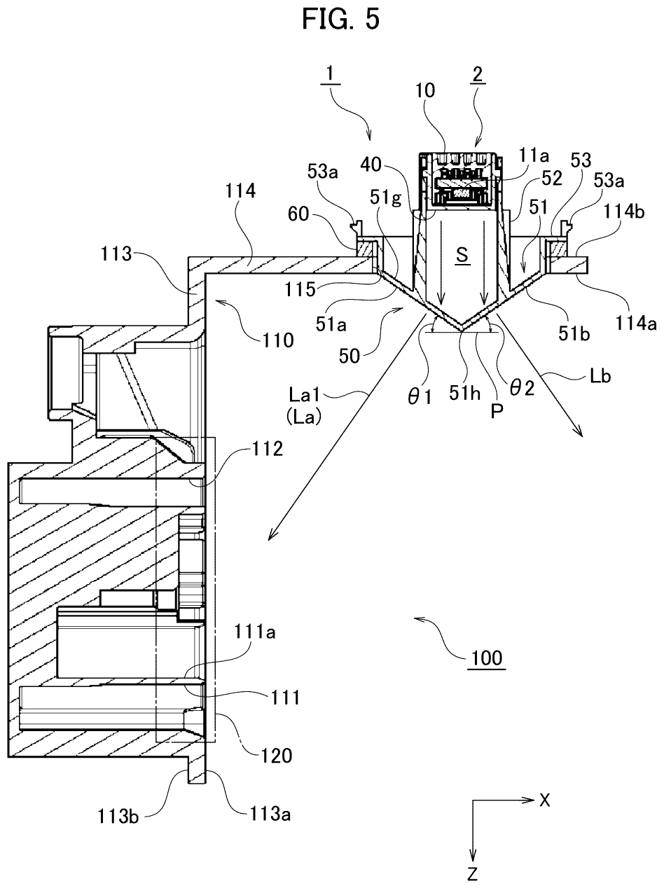

The first light source 11a emits monochromatic illumination light. The first light source 11a may be an Illumination LED that emits white light, for example. As will be described below with reference to FIG. 5, the first light source 11a is a light source suitable for emitting illumination light for illuminating the charging opening 120 in the charging inlet 100.

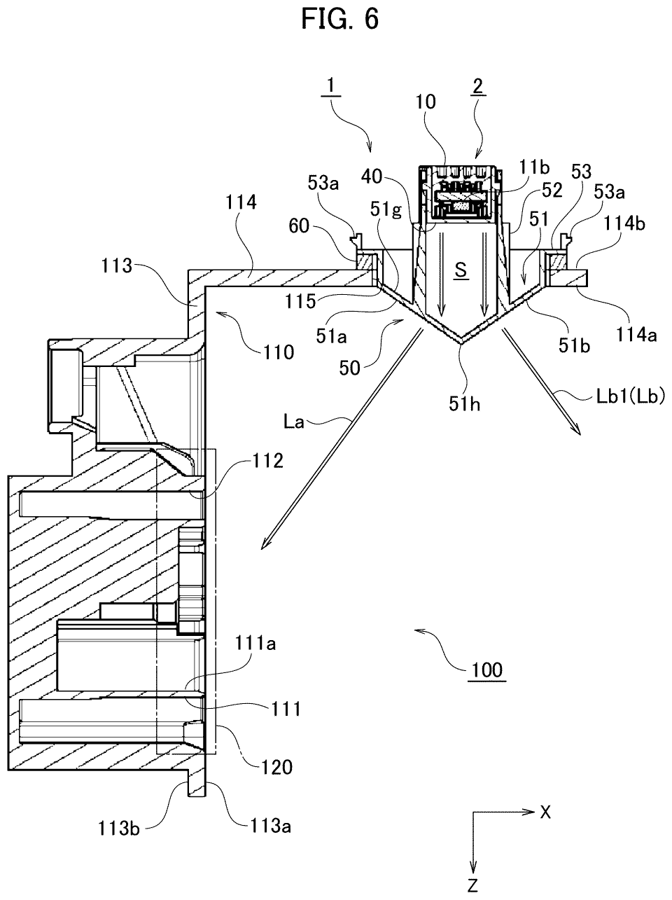

The second light source 11b emits light of variable colors. The second light source 11b may be an RGB color LED that emits multicolor light specified by RGB, for example. As will be described below with reference to FIG. 6, the second light source 11b is a light source suitable for indicator display indicating a charging state or the like in the charging inlet 100.

Further, the substrate 10 has a plurality of conductors 12 exposed from the first substrate surface 10a and the second substrate surface 10b. Each conductor 12 is brought into contact with any of the bus bars 30 and power is supplied to each light source 11. In the present embodiment, the first light source 11a and the second light source 11b are disposed on the side close to the front edge 10c in the Y direction of the substrate 10. Meanwhile each conductor 12 is disposed on the side close to the rear edge 10d in the Y direction of the substrate 10.

The housing 20 is made of a synthetic resin and is an insulating member for holding the substrate 10, for example. The housing 20 includes a housing body 21, a connector portion 22, and a plurality of locking claws 23.

The housing body 21 has a box-like shape as a whole, and accommodates the substrate 10 in a state of supporting the plurality of bus bars 30 by inserting the substrate 10 therein through a substrate insertion opening 21a. Further, the housing body 21 has a light emission opening 21b for radiating each of light emitted from the plurality of light sources 11 mounted on the substrate 10 outward, while accommodating the substrate 10 therein. In the present embodiment, a direction in which the substrate 10 is inserted through the substrate insertion opening 21a is a direction opposite to the Y direction. Further, a direction in which the light emission opening 21b is opened is the Z direction, which is the same as the light emission directions from the first light emission surface 13a of the first light source 11a and the second light emission surface 13b of the second light source 11b.

The connector portion 22 has a box-like shape as a whole and is connected to an external connector (not illustrated) that constitutes a part of the charging inlet 100. In the present embodiment, the illuminator 1 is attached to the charging inlet 100 installed in the vehicle. Therefore, the external connector here means a vehicle-side connector. As illustrated in FIG. 2A, the connector portion 22 has a rectangular cylindrical shape of which axial direction is a direction along the Y direction. The connector portion 22 is continuous with the housing body 21 in the Y direction. The inside of the connector portion 22 communicates with the outside through a connector frontage opening 22a, and at least partially communicates with the inside of the housing body 21. A terminal connecting portion 32 for each bus bar 30 enters the inside of the connector portion 22 from the inside of the housing body 21.

The plurality of locking claws 23 engage with a plurality of engagement holes 43 disposed in the inner cover 40 assembled to the housing body 21. This prevents the inner cover 40 from falling off from the housing body 21. In the present embodiment, there are two locking claws 23 disposed on an outer surface of each of two side wall 21c facing each other in the X direction, among walls constituting the housing body 21.

Each of the plurality of bus bars 30 is formed by means of sheet-metal processing, for example. Each bus bar 30 is a conductive member that electrically connects the substrate 10 with a plurality of terminals of the external connector connected to the connector portion 22 (hereinafter referred to as “external terminals”). In the present embodiment, there are two bus bars 30 corresponding to each conductor 12. All of the bus bars 30 have the same shape. Each bus bar 30 is coupled to the substrate 10 with a major planar surface thereof parallel to a YZ plane.

Each bus bar 30 has a substrate coupler 31 and a terminal connection portion 32. The substrate coupler 31 is coupled to the substrate 10 due to at least a part thereof being elastically deformed and sandwiching the substrate 10. In the present embodiment, the substrate coupler 31 is assembled to the substrate 10 such that a part thereof faces the rear edge 10d in the Y direction. When each bus bar 30 is coupled to the substrate 10, a part of the substrate coupler 31 contacts any of the conductors 12 on the substrate 10. The terminal connecting portion 32 is rod-shaped and has at least a tip exposed inside the connector portion 22. The terminal connecting portion 32 is connected to each external terminal when the external connector is connected to the connector portion 22. Each bus bar 30 is sometimes referred to as a “terminal” due to having the shape and function described above.

The inner cover 40 is formed of a colorless transparent or milky light-transmissive material such as a synthetic resin. The inner cover 40 protects the substrate 10 by covering a part of the substrate 10 held in the housing body 21. Specifically, the inner cover 40 is assembled to the housing body 21 so as to cover at least the substrate insertion opening 21a and the light emission opening 21b, which are openings of the housing body 21 facing outward. The inner cover 40 has the plurality of engagement holes 43 and a plurality of locking claws 44.

In the present embodiment, the plurality of engagement holes 43 are disposed on an outer surface of each of two side walls 41 facing each other in the X direction, among walls of the inner cover 40. As described above, any one of the two locking claws 23 of the housing body 21 engages with any one of the engagement holes 43.

The plurality of locking claws 44 engage with a plurality of engagement holes 52b disposed in the exterior cover 50 assembled on the inner cover 40. This prevents the inner cover 40 from falling off from the exterior cover 50. In the present embodiment, the locking claws 44 are disposed on an outer surface of each of the two side walls 41.

The substrate 10, the housing 20, the plurality of bus bars 30, and the inner cover 40 constitute one light source unit 2 by being assembled with each other. In other words, a state where the locking claws 44 of the inner cover 40 are engaged with the engagement holes 52b in the exterior cover 50 is equivalent to a state where the light source unit 2 is held on the exterior cover 50.

The exterior cover 50 is formed of a colorless transparent or milky light-transmissive material such as a synthetic resin, covers at least a part of a light emission space S by the plurality of light sources 11 in the illuminator 1, and is a member serving as the exterior of the illuminator 1. The exterior cover 50 includes a cover body 51, a light source unit attacher 52, and a frame 53.

The cover body 51 has a flat plate-shaped first light radiation wall 51a, a flat plate-shaped second light radiation wall 51b, a first side wall 51c, a second side wall 51d, a third side wall 51e, and a fourth side wall 51f.

The first light radiation wall 51a and the second light radiation wall 51b allow light emitted from the first light source 11a and the second light source 11b to pass therethrough to radiate the light to the outside. Both of the first light radiation wall 51a and the second light radiation wall 51b have lens functions. Further, the first light radiation wall 51a and the second light radiation wall 51b have the same shape and are continuous with a linear ridge 51h therebetween. When the illuminator 1 is attached to the charging inlet 100, the ridge 51h is in a posture along the Y direction.

Assuming that a direction toward the ridge 51h from the first substrate surface 10a of the substrate 10 on which the plurality of light sources 11 are arranged is defined as a first direction, the first direction corresponds to the Z direction. Further, the ridge 51h faces a part of a light emission surface 13 for each light source 11 in the first direction.

Further, as will be described in detail below, assuming that an arbitrary plane orthogonal to the first direction is defined as a hypothetical plane P (see FIG. 5), an inclination angle of each of outer surfaces of the first light radiation wall 51a and the second light radiation wall 51b relative to the hypothetical plane P is an acute angle. That is, suppose that the first direction corresponding to the Z direction is from an upper side to a lower side. In the above case, when an arbitrary XZ plane of the combination of the first light radiation wall 51a and the second light radiation wall 51b is assumed to be a cutting plane, a cross-sectional shape is a V-shape.

The first side wall 51c, the second side wall 51d, the third side wall 51e, and the fourth side wall 51f individually integrate the frame 53 with at least one of the first light radiation wall 51a and the second light radiation wall 51b.

The first side wall 51c and the second side wall 51d face each other in the X direction. The first side wall 51c is continuous with the first light radiation wall 51a, and the second side wall 51d is continuous with the second light radiation wall 51b. The lengths of the first side wall 51c and the second side wall 51d in the Y direction are the same as the lengths of the first light radiation wall 51a and the second light radiation wall 51b in the Y direction.

The third side wall 51e and the fourth side wall 51f face each other in the Y direction. The third side wall 51e is continuous with one end of each of the first light radiation wall 51a and the second light radiation wall 51b in the Y direction, and is continuous with one end of each of the first side wall 51c and the second side wall 51d in the Y direction. The fourth side wall 51f is continuous with the other end of each of the first light radiation wall 51a and the second light radiation wall 51b in the Y direction, and is continuous with the other end of each of the first side wall 51c and the second side wall 51d in the Y direction. Edges of the first side wall 51c, the second side wall 51d, the third side wall 51e, and the fourth side wall 51f form a rectangular opening end included in an arbitrary XY plane. Further, the maximum width dimension of the third side wall 51e and the fourth side wall 51f in the X direction is smaller than the length dimension of the first light radiation wall 51a and the second light radiation wall 51b in the Y direction.

That is, assuming that the first direction corresponding to the Z direction is from the upper side to the lower side, the cover body 51 is in the shape of a container having an upper opening. A part of each of the first side wall 51c, the second side wall 51d, the third side wall 51e, and the fourth side wall 51f constitutes a rectangular annular outer peripheral surface. When the illuminator 1 is attached to the charging inlet 100, the outer peripheral surface is in close proximity to and faces an edge of the illuminator attaching hole 115 disposed in the illuminator holder 114.

Further, the height dimensions of the first side wall 51c and the second side wall 51d in the Z direction such as other dimensions of the cover body 51 may be determined based on a state when the illuminator 1 is attached to the charging inlet 100. When the illuminator 1 is attached to the charging inlet 100, the frame 53, which will be described later, is supported by the second inner surface 114b of the illuminator holder 114 with the packing 60 therebetween, for example. At this time, the height dimensions of the first side wall 51c and the second side wall 51d in the Z direction may be set to the extent that the first side wall 51c and the second side wall 51d are not exposed outward from the second exterior surface 114a of the illuminator holder 114 (see FIGS. 5 and 6). As a result, portions of the illuminator 1 that are visible to the user are minimized. This is desirable because the illuminator 1 can have a simple shape in appearance.

The light source unit attacher 52 attaches the light source unit 2 on the back side of the cover body 51. The back side of the cover body 51 refers to a side facing inner surfaces 51g of the first light radiation wall 51a and the second light radiation wall 51b. As illustrated in FIG. 3, the light source unit attacher 52 may be a structure formed by combining a plurality of ribs that are partially continuous with each inner surface 51g.

Further, the light source unit attacher 52 has a pair of inner cover supporting pieces 52a facing each other in the X direction. Both of the pair of inner cover supporting pieces 52a have the engagement holes 52b. As described above, due to the engagement holes 52b being engaged with the locking claws 44 of the inner cover 40, the light source unit 2 is held by the exterior cover 50. The pair of inner cover supporting pieces 52a are arranged on the inner surfaces 51g of the cover body 51 so as to form the light emission space S therebetween. This does not inhibit light which has passed through the inner cover 40 from directly directing toward the inner surfaces 51g.

The frame 53 is a rectangular annular portion that is continuous with the opening end formed by the edges of the first side wall 51c, the second side wall 51d, the third side wall 51e, and the fourth side wall 51f, and protrudes outward from the opening end in either the X direction or the Y direction. The packing 60 is attached such that the frame 53 is supported by the second inner surface 114b of the illuminator holder 114 with the packing 60 therebetween when the illuminator 1 is attached to the charging inlet 100 as described above.

In order to prevent the illuminator 1 from falling off from the illuminator holder 114, the frame 53 may have a plurality of locking claws 53a used when the frame 53 is pressed against the second inner surface 114b using a pressing member (not illustrated).

The packing 60 is a waterproof member for preventing water from entering from the outside to the inside through the illuminator attaching hole 115. As described above, the packing 60 is a rectangular annular elastic member which is formed in accordance with the shape of the frame 53 and the shape of the illuminator attaching hole 115. The packing 60 may be a sponge packing, for example.

Next, the principle of light radiation by the illuminator 1 will be described.

First, as illustrated in FIG. 1, the illuminator 1 is held by the illuminator holder 114 of the charging inlet 100 in advance. At this time, the exterior cover 50 is attached to the illuminator attaching hole 115 formed in the illuminator holder 114 such that the first light radiation wall 51a and the second light radiation wall 51b are exposed outward from the illuminator attaching hole 115. Then, the illuminator 1 can be energized by connecting the connector portion 22, which is a part of the light source unit 2, to a vehicle-side external connector in a backside space of the charging inlet 100, that is, a space facing the second inner surface 114b of the illuminator holder 114.

FIG. 5 is a cross-sectional view of the illuminator 1 which is taken along V-V portion of FIG. 1 and illustrates a radiation state by the first light source 11a. A cutting plane in FIG. 5 is an XZ plane passing a part of the first light source 11a.

First, after the first light source 11a which emits monochromatic illumination light is turned on, light emitted from the first light source 11a travels through the light emission space S substantially in the Z direction and reaches the inner surfaces 51g of the first light radiation wall 51a and the second light radiation wall 51b. The light emission space S includes a space interposed between the light source unit 2 and the inner surfaces 51g of the exterior cover 50. The light emission space S is a space through which the light emitted from the first light source 11a can travel until the light reaches the first light radiation wall 51a or the second light radiation wall 51b.

As described above, the first light radiation wall 51a and the second light radiation wall 51b have a shape relationship such that, when an arbitrary XZ plane of the combination of the first light radiation wall 51a and the second light radiation wall 51b is assumed to be a cutting plane, a cross-sectional shape thereof is a V-shape. Therefore, light radiated from the exterior cover 50 based on light emitted from any of the light sources 11 is separated into first radiation light La radiated from the first light radiation wall 51a to the outside and second radiation light Lb radiated from the second light radiation wall 51b to the outside. FIG. 5 illustrates the first radiation light La and the second radiation light Lb based on light emitted from the first light source 11a using single-line arrows.

Further, an inclination angle of an outer surface of the first light radiation wall 51a relative to the hypothetical plane P is defined as a first inclination angle θ1. Meanwhile, an inclination angle of an outer surface of the second light radiation wall 51b relative to the hypothetical plane P is defined as a second inclination angle θ2. In the present embodiment, values of the first inclination angle θ1 and the second inclination angle θ2 are the same.

In the present embodiment, radiation light based on the light emitted from the first light source 11a of the first radiation light La is defined as illumination light La1. As illustrated in FIG. 5, the illumination light La1 is used to illuminate the charging opening 120 in the charging inlet 100 at night when the periphery of a vehicle is dark. When a position of the illuminator attaching hole 115 in the illuminator holder 114 is determined in advance, a specific value of the first inclination angle θ1 may be set by assuming that the illumination light La1 is directed to the charging opening 120.

FIG. 6 is a cross-sectional view of the illuminator 1 illustrating a radiation state by the second light source 11b. For convenience and to facilitate comparison with FIG. 5 for the first light source 11a, FIG. 6 is a drawing in the same cross section as FIG. 5. In FIG. 6, the light source 11 is the second light source 11b instead of the first light source 11a.

Second, after the second light source 11b which emits light of variable colors is turned on, light emitted from the second light source 11b also travels through the light emission space S substantially in the Z direction and reaches the inner surfaces 51g of the first light radiation wall 51a and the second light radiation wall 51b.

The first light radiation wall 51a is arranged such that the first radiation light La is directed toward the charging opening 120. Therefore, the second radiation light Lb radiated from the second light radiation wall 51b is radiated toward the outside of a vehicle, that is, toward a user who performs a power supply operation. FIG. 6 illustrates the first radiation light La and the second radiation light Lb based on light emitted from the second light source 11b using double-line arrows.

In the present embodiment, radiation light based on the light emitted from the second light source 11b of the second radiation light Lb is defined as display light Lb1. As illustrated in FIG. 6, the display light Lb1 is used as light for indicator display that allows the user to recognize an operation status such as a charging state at the time of charging in the charging inlet 100. The second light source 11b may emit light based on a radiation pattern corresponding to an operation status as follows, for example.

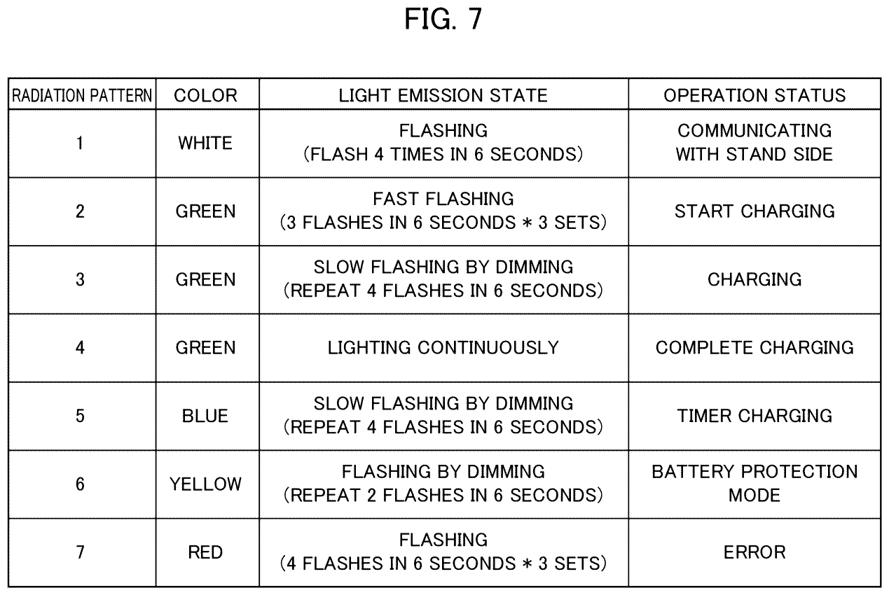

FIG. 7 is a table illustrating a radiation pattern of the second light source 11b corresponding to each operation status of the charging inlet 100.

In a first radiation pattern, the second light source 11b is white and flashes 4 times in 6 seconds. When the display light Lb1 is emitted in the first radiation pattern, as an operation status of the charging inlet 100, it is assumed that the charging inlet 100 is communicating with an external stand side where the charging connector is disposed.

In a second radiation pattern, the second light source 11b is green and repeats 3 fast flashes in 6 seconds for 3 sets. Hereinafter, “fast flash” means that a flash is faster than the flash in the first radiation pattern. When the display light Lb1 is emitted in the second radiation pattern, as an operation status of the charging inlet 100, it is assumed that charging is started.

In a third radiation pattern, the second light source 11b is green and repeats 4 slow flashes in 6 seconds by dimming. Hereinafter, “slow flash” means that a flash is slower than the flash in the first radiation pattern. When the display light Lb1 is emitted in the third radiation pattern, as an operation status of the charging inlet 100, it is assumed that charging is in progress.

In a fourth radiation pattern, the second light source 11b is green and is continuously lit. When the display light Lb1 is emitted in the fourth radiation pattern, as an operation status of the charging inlet 100, it is assumed that charging is completed.

In a fifth radiation pattern, the second light source 11b is blue and repeats 4 slow flashes in 6 seconds by dimming. When the display light Lb1 is emitted in the fifth radiation pattern, as an operation status of the charging inlet 100, it is assumed that a timer charging set to a desired charging time by a user is in progress.

In a sixth radiation pattern, the second light source 11b is yellow and repeats 2 flashes in 6 seconds by dimming. When the display light Lb1 is emitted in the sixth radiation pattern, as an operation status of the charging inlet 100, it is assumed that the charging inlet 100 is in a mode requiring battery protection.

In a seventh radiation pattern, the second light source 11b is red and repeats 4 flashes in 6 seconds for 3 sets. When the display light Lb1 is emitted in the seventh radiation pattern, as an operation status of the charging inlet 100, it is assumed that an error has occurred.

In addition to each radiation pattern illustrated in FIG. 7, an operation status type can be appropriately set. Further, a color and a lighting or flashing state in each radiation pattern can also be appropriately set.

In addition, when a position of the illuminator attaching hole 115 in the illuminator holder 114 is determined in advance, a specific value of the second inclination angle θ2 may be set by assuming that the display light Lb1 is directed to the user.

Next, an effect of the illuminator 1 will be described.

The illuminator 1 includes the plurality of light sources 11 and the exterior cover 50 which covers at least a part of the light emission space S by the plurality of light sources 11. The exterior cover 50 has the first light radiation wall 51a and the second light radiation wall 51b which allow light emitted from the plurality of light sources 11 to pass therethrough to radiate the light to the outside. The first light radiation wall 51a and the second light radiation wall 51b are colorless transparent or milky flat plates, and are continuous with each other with the linear ridge 51h therebetween. At least one of the plurality of light sources 11 emits light of variable colors.

In the above example, the light source 11 which emits light of variable colors corresponds to the second light source 11b.

The first light radiation wall 51a and the second light radiation wall 51b of the illuminator 1 are flat plates, and are continuous with each other with the linear ridge 51h therebetween. The first light radiation wall 51a and the second light radiation wall 51b are combined such that a cross-sectional shape thereof is a V-shape as exemplified above using each drawing. In other words, the first radiation light La radiated from the first light radiation wall 51a and the second radiation light Lb radiated from the second light radiation wall 51b are directed in different directions according to the inclination angles of the first light radiation wall 51a and the second light radiation wall 51b.

Therefore, by using at least one of the plurality of light sources 11 as a light source 11 which emits light of variable colors, a type of color emitted, a lighting or flashing state, or the like can be appropriately changed in accordance with various phenomena. This can display actual phenomena to the outside. In the above example, it is assumed that the illuminator 1 is installed in the charging inlet 100. In this case, the various phenomena correspond to a charging state and the like of a battery. Displaying the actual phenomena to the outside corresponds to indicator display for displaying a charging state or the like being made.

Meanwhile, at least one of the plurality of light sources 11 does not need to emit light of variable colors, for example, and may radiate white illumination light. Alternatively, the one light source 11 may constantly emit white light, although the one light source 11 can emit light of variable colors. By having this kind of light source 11, the second radiation light Lb radiated from the second light radiation wall 51b can be used as the display light Lb1 for indicator display, and the first radiation light La radiated from the first light radiation wall 51a can be used as the illumination light La1.

In addition, it is sufficient if the plurality of light sources 11 of the illuminator 1 emit light toward the first light radiation wall 51a and the second light radiation wall 51b which are continuous with each other. Therefore, the plurality of light sources 11 can be arranged in the same row and close to each other, and this is advantageous in simplifying an internal structure. Further, according to the illuminator 1, it is sufficient if at least the first light radiation wall 51a and the second light radiation wall 51b are exposed at a part where the illuminator 1 is installed. Therefore, an exposed portion of the exterior cover 50 can be made to have a simple shape, and this is advantageous in terms of design, in addition to simplification in shape. Still further, according to the illuminator 1, the color of the first light radiation wall 51a and the second light radiation wall 51b is colorless transparent or milky. Therefore, when all of the light sources 11 are turned off, the light sources 11 can be visually compatible with surrounding components in terms of appearance, and this makes it more advantageous in terms of design.

As described above, according to the present embodiment, it is possible to provide the illuminator 1 having an illumination function and an indicator function with a simple structure or shape.

Moreover, at least one light source different from the light sources 11 that emit light of variable colors of the plurality of light sources 11 may emit monochromatic illumination light.

In the above example, the light source 11 that emits monochromatic illumination light is the first light source 11a.

According to the illuminator 1, when the illumination light La1 which is a part of radiation light is determined to radiate the charging opening 120 in the charging inlet 100 as exemplified above, a more suitable illumination light source can be selected as at least one of the light sources 11.

Further, the illuminator 1 may have the substrate 10 on which the plurality of light sources 11 are mounted. A direction of the first substrate surface 10a of the substrate 10 on which the plurality of light sources 11 are arranged toward the ridge 51h is defined as the first direction. An inclination angle of an outer surface each of the first light radiation wall 51a and the second light radiation wall 51b relative to the hypothetical plane P orthogonal to the first direction may be an acute angle.

In the above example, the first direction corresponds to the Z direction. Further, in the above example, the inclination angles of the first light radiation wall 51a and the second light radiation wall 51b correspond to the first inclination angle θ1 and the second inclination angle θ2, respectively.

According to the illuminator 1, light emitted from each light source 11 is directed toward the first light radiation wall 51a and the second light radiation wall 51b in the first direction, and then the radiation light is separated into light travelling in different directions by the first light radiation wall 51a and the second light radiation wall 51b. In this case, since an inclination angle of each of the first light radiation wall 51a and the second light radiation wall 51b is an acute angle, the first radiation light La and the second radiation light Lb travel such that they are gradually separated from each other. Therefore, it is possible to make the first radiation light La and the second radiation light Lb easier to use by imparting different functions, such as using the first radiation light La as an illumination function and using the second radiation light Lb as an indicator function.

Further, in the illuminator 1, when the inclination angle of the outer surface of the first light radiation wall 51a relative to the hypothetical plane P is the first inclination angle θ1, and the inclination angle of the outer surface of the second light radiation wall 51b relative to the hypothetical plane P is the second inclination angle θ2, values of the first inclination angle θ1 and the second inclination angle θ2 may be the same.

According to the illuminator 1, a cross-sectional shape of the outer surfaces of the combination of the first light radiation wall 51a and the second light radiation wall 51b is an isosceles triangle with an edge of the ridge 51h as an apex. This can simplify a shape of an exposed portion of the exterior cover 50. The simplification of the shape of the exterior cover 50 is advantageous in that the exterior cover 50 can be easily produced, for example.

Further, the illuminator 1 may have the annular packing 60. The exterior cover 50 may have the annular frame 53 to which the packing 60 is attached, and a plurality of side walls for integrating the frame 53 with at least one of the first light radiation wall 51a and the second light radiation wall 51b.

In the above example, the plurality of side walls correspond to the first side wall 51c, the second side wall 51d, the third side wall 51e, and the fourth side wall 51f.

As in the above example, even when the illuminator 1 is installed in the charging inlet 100 where a part may be exposed to the outside of a vehicle during a power supply operation, the illuminator 1 can prevent water from entering from the outside to the inside of the vehicle as a waterproof function.

In addition, the exterior cover 50 of the illuminator 1 may be attached to the illuminator attaching hole 115 which constitutes a part of the charging inlet 100 such that the first light radiation wall 51a and the second light radiation wall 51b are exposed outward from the illuminator attaching hole 115. Further, the exterior cover 50 may be attached to the illuminator attaching hole 115 such that the first radiation light La radiated from the first light radiation wall 51a is directed toward the charging opening 120 in the charging inlet 100.

As an illumination function of the illuminator 1 installed in the charging inlet 100, the first radiation light La can be used to radiate the entire charging opening 120. Therefore, it is possible to enhance work efficiency when a user performs a power supply operation at night or the like.

Further, the light source 11 that can emit light of variable colors in the illuminator 1 may emit light based on a radiation pattern corresponding to an operation status at the time of charging using the charging inlet 100.

As an indicator function of the illuminator 1 installed in the charging inlet 100, the user can be made to recognize various radiation patterns by the second radiation light Lb, and as a result, the user can be made to recognize various operation statuses such as charging states.

In the above example, the illuminator 1 has been described as being installed in the charging inlet 100 of the vehicle and illuminating the charging opening 120, but the present invention is not limited thereto. In other words, the illuminator 1 may be used for illuminating a component other than the charging opening 120, or may be installed in various apparatuses other than the charging inlet 100 of the vehicle.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

1. An illuminator comprising:
a plurality of light sources; and
an exterior cover that covers at least a part of a light emission space by the plurality of light sources, wherein
the exterior cover includes a first light radiation wall and a second light radiation wall that allow light emitted from the plurality of light sources to pass therethrough to radiate the light to the outside,
the first light radiation wall and the second light radiation wall are colorless transparent or milky flat plates and are continuous with each other with a linear ridge therebetween, and
at least one light source of the plurality of light sources emits light of variable colors.

2. The illuminator according to claim 1, wherein
at least one light source of the plurality of light sources other than the at least one light source that emits the light of variable colors emits monochromatic illumination light.

3. The illuminator according to claim 1 comprising:
a substrate on which the plurality of light sources are mounted, wherein
assuming that a direction toward the ridge from a first substrate surface of the substrate on which the plurality of light sources are arranged is defined as a first direction,
an inclination angle of an outer surface of each of the first light radiation wall and the second light radiation wall relative to a hypothetical plane orthogonal to the first direction is an acute angle.

4. The illuminator according to claim 3, wherein
assuming that the inclination angle of the outer surface of the first light radiation wall relative to the hypothetical plane is a first inclination angle, and the inclination angle of the outer surface of the second light radiation wall relative to the hypothetical plane is a second inclination angle, values of the first inclination angle and the second inclination angle are the same.

5. The illuminator according to claim 1 comprising:
an annular packing, wherein
the exterior cover includes:
an annular frame to which the packing is attached; and
a plurality of side walls for integrating the frame with at least one of the first light radiation wall and the second light radiation wall.

6. The illuminator according to claim 1, wherein
the exterior cover is attached to an illuminator attaching hole that constitutes a part of a charging inlet such that the first light radiation wall and the second light radiation wall are exposed outward from the illuminator attaching hole, and the light radiated from the first light radiation wall is directed toward a charging opening in the charging inlet.

7. The illuminator according to claim 6, wherein
the at least one light source that emits the light of variable colors emits the light based on a radiation pattern corresponding to an operation status at the time of charging using the charging inlet.
